(19) United States
(12) Patent Application Publication
(10) Pub. No.: US 2010/0108604 A1
(43) Pub. Date: May 6, 2010

(54) MEMBRANES FILLED WITH POROUS HOLLOW PARTICLES

(76) Inventors: Alexander AERTS, Antwerpen (BE); Steliana Aldea, Leuven (BE); Johan Martens, Huldenberg (BE); Katrien Vanherck, Hasselt (BE); Ivo Vankelecom, Blanden (BE)

Correspondence Address: BACON & THOMAS, PLLC, 625 SLATERS LANE, FOURTH FLOOR, ALEXANDRIA, VA, 22314-1176, US

(21) Appl. No.: 12/614,810

(22) Filed: Nov. 9, 2009

Related U.S. Application Data
(63) Continuation-in-part of application No. PCT/BE2008/000040, filed on May 13, 2008.

(30) Foreign Application Priority Data
May 11, 2007 (GB) 0709115.0

(51) Int. Cl. B01D 69/12; B01D 61/14

(52) U.S. Cl. 210/640; 210/285; 210/490; 210/650

(57) ABSTRACT

The present invention provides a new composite material comprising a polymer matrix comprising dispersed molecular sieve porous particles of which at least part are hollow particles, meaning that the particles comprise a shell enclosing cavities, of which the volume is at least two times larger than the average volume of the pores comprised in the shell of such particle. The invention further relates to membranes comprising such materials as well as the use of such membranes.

### CROSS REFERENCE TO RELATED APPLICATIONS

This application is a continuation-in-part of International Application No. PCT/BE2008/000040, filed May 13, 2008, which is hereby incorporated by reference, which claims the benefit of British Application No. GB 0709115.0 filed May 11, 2007, which is also hereby incorporated by reference.

### FIELD OF THE INVENTION

The present invention relates to a new polymer material comprising dispersed porous particles of which at least part are hollow particles, meaning that the particles comprise a molecular sieve porous shell enclosing one or more cavities and wherein the volume of any such cavity is at least 8 times, more preferably at least 100 times, most preferably at least 1000 times larger than the average volume of the pores in the shell of such particle. The invention further relates to membranes comprising such materials.

### BACKGROUND OF THE INVENTION

Pervaporation is the purification or separation of liquids by partial evaporation through a membrane and is uniquely characterised by an evaporation step of the transported compounds at the permeate side of the membrane. The liquid stream, containing two or more components is placed in contact with one side of a non-porous, preferably polymeric membrane while a vacuum or gas purge is applied to the other side. The components in the liquid stream sorb into the membrane and permeate to the other side where they are evaporated into a vapour phase (hence ‘pervaporation’). The vapour phase is then condensed. The vacuum pump or sweep gas continuously removes the evaporated compounds on the permeate side to maintain the driving force over the membrane and keep the separation going. Different components have different affinities for the membrane and thus different diffusion rates, so that a component with low concentration in the feed liquid mixture can be highly enriched in the permeate. (Mulder, 1996).

Pressure-driven processes to separate liquids are clearly different from pervaporation. They involve a process of separating two or more components over a membrane by means of a pressure gradient, generated by applying pressure to the feed side of the membrane, either a gas pressure or a mechanical pressure. The pressure-driven membrane processes can be divided into 4 groups, depending on the applied pressure, for which typical values are given in table 1 (Mulder, 1996). When referring to solvent applications in specific, the term solvent resistant nanofiltration (SRNF) also includes reverse osmosis and the high pressure end of ultrafiltration.

TABLE 1
Pressure driven membrane processes

| | | Typical flux | Morphology |
|---|---|---|---|
| | Typical pressure | (l/m² bar | of the |
| Membrane process | (bar) | h) | Selective layer |
| Microfiltration | 0.1-2 | >50 | Porous |
| Ultrafiltration | 1-5 | 10-50 | Porous |
| Nanofiltration | 5-20 | 1.4-12 | Porous/dense |
| (Hyperfiltration) | | | |
| Reverse Osmosis | 10-100 | 0.05-1.4 | Dense |

In addition, feeds can be of a gaseous phase. The permanent gases or vapours are then separated in a gas separation, respectively vapour permeation, as driven by a pressure gradient applied as a pressure at the feed side or as a vacuum at the permeate side.

The volume flux through the membrane depends on the pressure drop over the membrane as well as on the hydraulic resistance of the membrane. The inverse of hydraulic resistance, the hydraulic permeability, is generally used. This parameter depends on the pore size and structure, the porosity and the thickness of the membrane.

The filled membranes of the state of the art comprise fillers whose bulk pores are not substantially different from the pores at the circumsphere of the particle. These state-of-the-art membranes can comprise a variety of particles. The general aim for adding porous fillers is to create pathways for molecular transport with a lower mass transfer resistance than that of the bulk polymer to increase permeability. In some cases, a well-defined pore structure can discriminate between two permeating molecules, thus simultaneously increasing the membrane selectivity.

Vankelecom et al. (1995) used ZSM-5 and Zeolite Y filled PDMS membranes for pervaporation of water/alcohol mixtures. The zeolites mainly influenced sorption in the membrane by inducing an extra cross-linking effect, hence limiting extensive swelling. Boom et al. (1998) carried out pervaporation of toluene/methanol mixtures with rubbery polymers containing zeolite NaX or silicalite-1 where in both eases, methanol flux was increased and toluene flux was decreased. Water flux was increased upon incorporation of the hydrophilic zeolite Y, while all fluxes decreased with ZSM-5 incorporation due to partial retention of the molecules in the zeolite crystals. Xin Chen et al. (Xin Chen et al., 2000) incorporated zeolite A in polysulphone membranes to increase both permeability and selectivity in O₂/N₂ separations. Other examples of filled polymer membranes for pervaporation are numerous (Chandak et al., 1997; Gao et al., 1996; Jia et al., 1992; Chen et al., 2001; Vankelecom et al., 1997; Kulprathipanja, 2003).

WO2005/058465 discloses elastomers filled with various filler types for applications in pressure-driven processes, such as solvent-resistant nanofiltration. Different organic and inorganic materials were proposed for use as a filler in dense elastomeric membranes. These fillers were all molecular sieves or other porous materials with nanometer dimension windows, pores, and channels (being zeolites, mesoporous materials and silica, alumina, titania or carbon molecular sieves) or any particle in a solid state that can interact chemically and/or physically with the elastomer to cause an additional cross-linking, sufficient to reduce swelling in high-swelling solvents and/or at high temperatures.

Most of the above described fillers are micron-sized and thus limit the minimal thickness of a defect-free composite membrane to a few micrometers. The composite membranes consequently result in low permeabilities. Preparing submicron particles could be a solution to this problem, but difficulties arise in dispersing these colloidal particles in the polymer matrix. (Moermans et al. 2000).

### SUMMARY OF THE INVENTION

In a first object the present invention provides composite materials comprising a polymer matrix wherein molecular sieve porous particles are dispersed and wherein at least part of these particles are hollow particles comprising a molecular sieve porous shell enclosing one or more cavities and wherein the volume of any such cavity is at least 8 times, more preferably at least 100 times, most preferably at least 1000 times larger than the average volume of the pores in the shell of such particle. In a second object the invention provides membranes comprising such materials as well as the use of these membranes in gas or liquid separation processes.

The present invention relates to a new type of composite material, comprising a polymer matrix and hollow particle (μm-sized or smaller) with a porous shell as fillers. This composite material is particularly suitable for the production of membranes. The presence of hollow fillers in the polymer matrix may improve the membrane characteristics in the same way as is obtained with fillers of the prior art, for instance by reducing the swelling of the membrane through interaction with the polymer or by providing selective and/or faster transport of certain molecules. However, the use of hollow particles has the additional advantageous that permeabilities can be improved by reducing the effective thickness (D_{E}) of the membrane, calculated as the total thickness (D_{N}) of the selective layer minus the cross-sectional diameter of the voids in the particles, as represented in FIG. 1.

Aspects of the present invention are realised by a composite material comprising a polymer matrix comprising dispersed molecular sieve porous particles characterised in that at least part of said particles are hollow particles, which comprise a molecular sieve porous shell enclosing one or more cavities and wherein the volume of such cavity is at least 8 times the average volume of the pores in the shell of such particle.

Aspects of the present invention are also realised by a membrane comprising the-above-mentioned composite material, with the porous molecular sieve particles being preferably selected to interact with the polymer matrix in order to provide additional cross-linking of the polymer matrix.

Aspects of the present invention are also realised by the use of the above-mentioned membrane in a gas or liquid separation process, with the liquid separation process being a pressure driven process or an evaporation process being preferred.

### LEGENDS TO THE FIGURES

FIG. 1: Schematic representation of a composite membrane with a selective layer composed of a hollow-particle-filled polymer on top of a support. The shaded area represents the porous shell of the filler. Outer and inner diameters of the hollow particles are indicated by dᵢₙ and dₒᵤₜ. Nominal thickness (total thickness) and effective thickness of the selective layer are indicated by D_{N} and D_{E}.

FIG. 2: SEM pictures of a 30 wt % ZSM-5 filled PDMS membrane (20% in hexane) on top of a 15% polyimide support. Scale bar is 50 μm in 2a and 10 μm in 2b.

FIG. 3: SEM pictures of a 15 wt % nanocrystal-silicalite-1 filled PDMS (7 wt % in hexane) membrane on top of a 15 wt % polyimide support. Scale bar in 3a is 50 μm, and 5 μm in 3b.

FIG. 4: SEM pictures of 15 wt % hollow silicalite sphere filled PDMS (7 wt % in hexane) on top of a 15 wt % polyimide support.

### DETAILED DESCRIPTION OF THE INVENTION

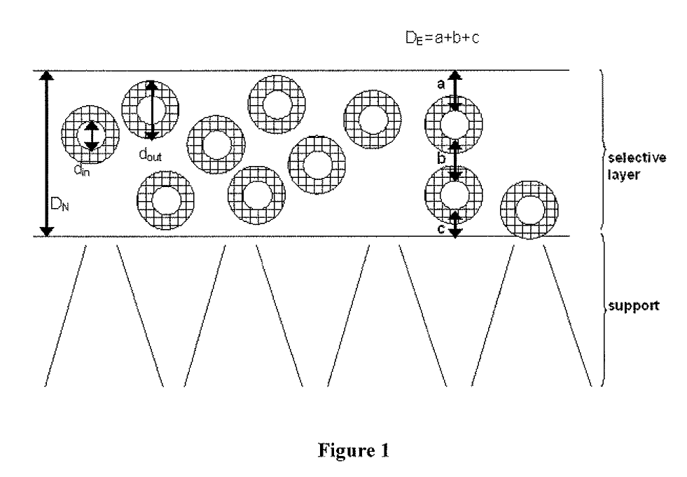

The present invention is based on the finding that membranes comprising a polymer matrix at least partly filled with dispersed particles comprising a molecular sieve porous shell enclosing one or more cavities have advantageous characteristics. The presence of such hollow porous particles in the polymer matrix provides a higher permeability to the composite membrane without the need for thinner composite layers. This higher permeability can be understood when considering that the effective thickness of the filled polymer layer is the sum of the shell thicknesses of the packed hollow particles plus the thickness of the polymer matrix forming that same cross-section (shown as a+b+c in FIG. 1), since the permeating compounds can move unhindered through the hollow part of the fillers. Moreover, an appropriate selection of the material of the hollow particles, such that the outer surface of the shell of these filler particles can chemically and/or physically interact with the polymer matrix, allows to cross-link the polymer phase in order to limit its swelling and thus preventing loss of selectivity of the membrane.

In the context of the present invention the term “molecular sieve porosity” refers to the presence in a material of pores, said pores having a diameter varying between 0.3 and 50 nm, more preferably between 0.3 and 10 nm and most preferably between 0.3 and 2 nm.

In a first object the present invention relates to composite materials comprising a polymer matrix wherein molecular sieve porous particles (also referred to as filler particles) are dispersed, characterised in that at least a part of the particles are hollow particles, which comprise a molecular sieve porous shell enclosing one or more cavities and wherein the volume of any such cavity is at least 8 times, more preferably at least 100 times, most preferably at least 1000 times, for instance one million times larger than the average volume of the pores in the shell of such particle. In case the cavities in said hollow particles are spherically shaped, the diameter of such cavity is at least two times the average diameter of the pores in the shell of the hollow particle, preferably the diameter of a cavity is at least 10 times, more preferably at least 100 times, for instance at least 1000 times the average diameter of the pores in the shell of the hollow particle. Furthermore; the shell of a hollow particle may constitute between 1 and 99% of the total particle volume.

The said cavities can either be fully or partially enclosed by the shell. In the latter case the particle surface comprise one or more openings connected to the said cavities.

Typically the filler particles (porous molecular sieve particles) comprised in the composite material are smaller than 1 μm, for instance smaller than 500 nm. In a preferred embodiment more than 30%, preferably more than 60%, most preferably more than 90% of the filler particles (porous molecular sieve particles) dispersed in the composite material according to the present invention are hollow molecular sieve particles. Preferred porous molecular sieve particles are selected from the group consisting of zeolites, carbon-molecular sieves, metal organic frameworks and porous silica.

Particularly suitable polymers (polymer materials) for use in the composite materials according to the present invention are polyvinylidene fluoride, polyacrylonitrile, polyvinylalcohol, polyimide, polysulfone, polyetheretherketone, polydimethylsiloxane and polybenzimidazole amongst others.

The hollow filler particles may be any hollow particle (spherical, cubic, cylindrical are any other shape) of (sub)micrometer diameter and with a molecular sieve porous shell of inorganic or organic nature. Different suitable hollow particles have been previously disclosed. Botterhuis et al. (2006) created hollow spheres (outer diameter 0.6-1.2 μm) with a silica shell (thickness 60-100 nm, pore diameter 3-6 nm) by emulsion templating. Similar emulsion templating processes were employed by Jan et al. (2005), creating hollow silica spheres with block copolypeptides as directing agent (outer diameter 20-250 nm), by Fowler et al. (2001) with ceryl-trimethyl-ammonium bromide (CTAB) as directing agent (outer diameter average 1 μm, shell thickness 20 nm), by Hentze et al, (2003) by templating with mixtures of different surfactants (outer diameter 60-120 nm, shell thickness 1-2 nm) and by Chen et al. (2004) with CTAB and CaCO₃ nanoparticles. Ding et al (2004) used polymer particles as substrate for silica coatings and created hollow silica particles (outer diameter ˜100 nm, shell thickness 20 nm) by calcination. Caruso et al. (1998) prepared inorganic and hybrid hollow spheres (outer diameter 720-1000 nm, shell thickness 10-100 nm) by electrostatic layer-by-layer self-assembly to polystyrene nanoparticles. There are also abundant examples of zeolite-shell hollow spheres in the scientific literature. Many different synthesis techniques are employed to obtain hollow zeolite spheres of a variety of sizes and with different characteristics. Hollow spheres with a silicalite-1 (or other zeolite) shell and of different submicrometer sizes have been synthesized by Naik et al. (2003) by self-assembly (outer diameter of 100-300 nm, cell thickness of 10-20 nm). Layer-by-layer deposition of silicalite-1 crystals (Wang, Yang et al. 2000, Yang, Wang et al. 2002) and of Zeolite 13, ZSM-5, and TS-1 (Yang, Wang et al. 2002) on a polystyrene template followed by calcination was successfully applied to create hollow zeolite-shell microspheres with outer diameters of 0.5-10 μm. Water droplets dispersed in toluene were used by Kulak et al. (2002) as a template for the assembly of zeolite nanocrystals into microspherulites, with outer diameters ranging from 1-20 μm and shell thicknesses up until 1 μm. Lee and Schantz made silicalite-1 spheres (3-10 μm) in non-ionic micro-emulsions, with morphology depending on temperature and chosen surfactant (2005) and in water-oil-surfactant systems (2004). Xiong et al. (2005) describes zeolite spheres with a core-shell structure that were fabricated by a combination of pulsed laser deposition (PLD) and vapor-phase crystallization. Hollow spheres (outer diameter 200 nm) with ZSM-5 shells were produced by a method which didn't require any template by Venkatathri, patented in 2006 (FR 2834636A1). Hollow tubes (outer diameter 2 μm) with zeolitic shell were prepared by Song et al. (2004). Also, crystalline carbon hollow spheres (750 nm) have been prepared by Wang et al. (2006) using silica spheres as template. Bourlinos et al. (2001) created hollow spheres with a diameter in tens of micrometers and a shell of 3-5 μm thickness, existing of colloidal clay layers. Cheng et al. (2006) prepared hollow polymeric nanospheres, nanocubes and nanoplates of 35-600 nm in diameter using silverbromide as a template.

In a second object the present invention provides membranes comprising a said composite material as well as the use of such membranes in gas or liquid separation processes. Membranes according to the present invention are particularly useful in pressure driven membrane processes with liquid feeds, including pervaporation processes microfiltration, ultrafiltration, nanofiltration, hyperfiltration and reverse osmosis. In these processes the membranes can be used to treat feed solutions that comprise solutes dissolved in a solvent system. The feed solution is separated by the membranes into a solute enriched retentate and a more dilute permeate. The solutes may be organic or inorganic molecules with a molecular weight that can range from 50 to 10000 Dalton, preferably 200 to 1000 Dalton. The solvent system can be one solvent, which is part of the aromatic hydrocarbons, the aliphatic hydrocarbons, halogenated solvents, alcohols, ketones, ethers, aldehydes, esters, nitriles, amines, . . . or can be combinations thereof. The pressure applied as a driving force for transport ranges from 0.5 to 100 bar, more preferably from 5 to 50 bar. Working temperatures typically, but not exclusively, range from 0° C. to 100° C.

In a particular embodiment the membranes according to the present invention comprise elastomers as polymer matrix filled with strongly interacting, hollow filler particles. Such membranes are particularly useful for pressure-driven membrane processes since swelling is reduced to such a level that high selectivity can be maintained both in strong-swelling solvents and at high temperatures.

In the preparation of a composite membrane according to the present invention, the hollow filler particles are first dispersed in an appropriate solvent. To improve the dispersion, ultrasonic wave treatment, high speed mixing, modification reactions, . . . can be applied. Obviously, the dispersing solvent should be able to dissolve the polymer as well, or at least, should be partially miscible with the solvent in which the membrane forming polymer is dissolved. The content of solid components, i.e. filler and polymer, in this dispersion, may range from 1 wt % to 70 wt %, preferably 5 wt % to 30 wt %. The dispersion is stirred for a certain time to allow (polymer/filler) interactions to establish, to improve dispersion and possibly to let a chemical reaction take place. When appropriate, the dispersion can be heated.

Thereafter, the (polymer/filler) dispersion can be cast on a non-porous support from which it is released afterwards to form a self-supporting film. It is more preferred to coat the dispersion on a polymeric or ceramic support with surface pores in the range from 5 to 1000 ANG, preferably from 10 to 50 ANG. This porous support can be treated first, for instance to diminish intrusion. One way tot realise this is by soaking it previously with a solvent, which has a low affinity for the dispersion. Also, the support can be treated with adhesion promotors.

After casting or coating, the solvent is evaporated and, if necessary, a heat treatment can be applied to finish the cross-linking reactions. The heat treatment can possibly occur under vacuum conditions to remove the remaining solvent. The resulting supported membranes have a dense separating layer, which consists of a filled elastomer. The thickness of this selective layer can range from 0.01 μm to 100 μm, preferably from 0.1 μm to 10 μm.

In case an additional cross-linking of the polymer matrix is desired, the establishing of the additional cross-linking can be checked by measuring the swelling of the filled elastomers in high-swelling solvents, like toluene, ethyl acetate and to compare the swelling with the swelling of the unfilled membrane. Swelling measurements typically proceed as follows:

Dried pieces of the membrane are weighed and submerged in the solvent until swelling equilibrium is reached. The swelling S of membrane x is then:

S=1/ρ(solv)*(mₑ−m₀)/m₀

where mₑ,=weight of the membrane at swelling equilibrium, m₀=weight of the dried sample and ρ(solv)=density of the used solvent (g/ml).
The swelling reduction ΔS in a certain solvent can be expressed by following equation:

ΔS=100*(Sref−Sfilled)/Sref

where ΔS=swelling reduction, Sref=swelling of the membrane without filler in this solvent and Sfilled=swelling of membrane with filler in the same solvent.
The swelling reduction ΔS for a given elastomer depends on the type of filler, its interactions with the elastomer and the filler content.
The invention is further illustrated by way of the understanding non-limiting examples.

### EXAMPLES

### Materials

The PDMS (RTV-615 A and B, and the adhesion promotor (SS4155) were obtained from General Electric Corp. (USA). Component A is a prepolymer with vinyl groups. Component B has hydride groups and acts as cross-linker.

The polyimide support layer was laboratory-prepared by the phase-inversion process using matrimid 9725 (obtained from Huntsman), NMP as solvent and THF as volatile co-solvent. Weight percentage of polyimide was 10-15%, the ratio of THF:NMP was 0 to 0.33. A 150 μm film of the polymer solution was cast on a polypropylene non-woven support by an automatic casting device. The film was allowed to evaporate for 30s after which it was immersed in a de-ionised water bath and further exchanged by isopropanol (2 hours) and by a solution of glycerol:isopropanol (40:60) for three days.

### Example 1

Hollow spheres of 1-5 μm in size with a silicalite-1 shell were laboratory prepared from a so-called ‘clear solution’ (ratio TEOS:TPAOH:H2O was 25:9:400) and an ethanolic solution of CTAB (5 wt %). An equal volume of CTAB 5% in ethanol was added dropwise to an amount of clear solution whilst vigorously stirring. The solution was poured in a screw-capped bottle, closed off very well and put in an oven at 90° C. for 4 days. The resulting precipitated white sol was washed thoroughly with ethanol and filtrated by buchner filtration. It was then dried at 60° C. and calcined at 500° C. (rate 1°/min) for 5 hours. Before using in filled PDMS preparation, the powder was dried at 110° C.

### Example 2

Unfilled PDMS (7 wt % and 15 wt %) was prepared as a reference in hexane with RTV 615A and RTV 615B components present in a 10:1 ratio, as proposed by the manufacturer to be the ratio for optimal curing. The mixture was prepolymerised for 1 h at 60° C. and poured in a petri-dish. The solvent was allowed to evaporate for several hours and the resulting film was cured at 110° C. Pieces of the resulting membrane were weighed and submerged in the solvent until swelling equilibrium was reached.

Swelling (ml/g)

| Wt % PDMS | Toluene | DCM |
|---|---|---|
| 7 | 1.26 | 0.97 |
| 15 | 1.23 | 1.06 |

### Example 3

PDMS (20 wt % in hexane) filled with micronsized zeolite crystals (ZSM-5 (CBV3002) and USY (CBV780) both 30 wt % in PDMS) was prepared as a reference in hexane with RTV 615A and RTV 615B components present in a 10:1 ratio. The zeolite powder was dispersed in hexane. To improve the dispersion, a treatment of one hour in an ultrasonic bath was applied to break crystal aggregates. The cross-linker (RTV 615B) was added to the zeolite dispersion and this mixture was stirred at 40° C. for two hours to allow sufficient time to establish strong interactions between both phases. Finally, the prepolymer (RTV 615A) was added and the mixture was stirred for another hour at 60° C. The (PDMS−filler) solution was poured in a petridish and treated the same way as described in EXAMPLE 2.

Swelling (ml/g)

| Filler | Toluene | DCM |
|---|---|---|
| USY | 0.47 | 0.56 |
| ZSM-5 | 0.63 | 0.66 |

### Example 4

PDMS (2-8 wt % in hexane) filled with nanosized silicalite-1 (100-200 nm, 15-20% in PDMS) were prepared as in EXAMPLE 3. The (PDMS-filler) solution was poured in a petridish and treated the same way as described in EXAMPLE 2.

| | | |
|---|---|---|
| PDMS | Si-1 | Swelling (ml/g) |

| [wt %] | [wt %] | Toluene | DCM |
|---|---|---|---|
| 8 | 20 | 0.71 | 0.20 |
| 7 | 15 | 0.75 | 0.67 |
| 5 | 20 | 0.57 | 0.16 |
| 2 | 20 | 0.78 | 0.55 |

### Example 5

PDMS filled with 15 wt % of hollow Si-1 shelled fillers (as in EXAMPLE 1) was prepared as in EXAMPLE 3. The (PDMS-filler) solution was poured in a petridish and treated the same way as described in EXAMPLE 2.

The swelling of the membrane loaded with 15 wt % hollow filler was measured and compared with the swelling of the reference membrane prepared in EXAMPLE 1. The content of the solid components (PDMS+filler) in the casting solution was again 7 and 15%.

| | | | Swelling reduction % | |
|---|---|---|---|---|
| (PDMS + filler) | Swelling (ml/g) | | (Compared to EXAMPLE 1) | |
| wt % | toluene | DCM | Toluene | DCM |
| 7 | 1.16 | 0.72 | 7.7 | 24.9 |
| 15 | 1.49 | 1.21 | −20.9 | −14.7 |

It is obvious from this EXAMPLE that the swelling test method as described in EXAMPLE 2 may be not suitable for testing the swelling reduction of hollow-particle filled polymers as this method does not account for the filling of the cavities with the solvent.

### Example 6

### Filtration Experiments with Unfilled PDMS Membrane (as a Reference)

The membranes used in EXAMPLES 2-3 to determine the swelling were self-supporting in order to minimize the experimental error on the measurements. On the other hand, the membranes used in EXAMPLE 4 are thin films cast on a supporting layer. A 15 wt % and a 7 wt % PDMS solution (RTV 615 A:B=10:1) in hexane was prepolymerised for 1 h at 60° C. The solvent-exchanged polyimide support was wiped off with tissue paper and dried at 110° C. for 1 hour before taping it to an INOX plate. Then, the PDMS solution was coated on the support by tilting the plate at an angle of 60° and pouring the polymer solution on the support. After evaporation of the hexane, cross-linking was completed in an oven at 110° C. Resulting thicknesses were 5 μm for the 7% PDMS membrane and almost 10 μm for the 15% PDMS membranes as determined by SEM.

Filtrations were done in a stainless steel nanofiltration cell with 12.6 cm² membrane surface area. The feed solution consisted of a 35 μM Bengal rose solution in isopropanol. 50 ml of the feed solution was poured in the cell, and the cell was pressurised with nitrogen to 15 bar. Permeate samples were collected in cooled flasks as a function of time, weighed and analyzed. All reported values are equilibrium measurements.

The solvent flux J(1/m² bar h) is the total amount permeated (1) per unit time (h), per square meter of membrane (m²) and per unit of pressure (bar).

The rejection R (%) at steady state is a measure for the ability of a membrane to retain a certain solute. It is defined as follows:

R=100*(1−C/C_{f})

with C, the concentration in the permeate and C_{f} the concentration in the feed.

| | | | | Permeability |
|---|---|---|---|---|
| | Thickness of | | | normalized |
| PDMS | selective layer | Permeability | Rejection | for thickness 3 μm |
| [Wt %] | (μm) | (l/m² bar h) | (%) | (l/m² bar h) |
| 7 | 5 | 0.15 | 99.9 | 0.25 |
| 15 | 10 | 0.06 | 99.9 | 0.2 |

### Example 7

### Filtration Experiments with PDMS Membranes Filled with Micronsized Zeolite Filler

PDMS+filler solutions (20% in hexane) with fillers ZSM-5 and USY (30% in PDMS) in EXAMPLE 3 were made as in EXAMPLE 3. The membranes were made as in EXAMPLE 6. The thicknesses of the filled membranes are 30 nm for the USY-filled PDMS and 20 μm for the ZSM-5-filled PDMS.

| | | | | Permeability |
|---|---|---|---|---|
| | Thickness of | | | normalized for |
| | selective layer | Permeability | Rejection | thickness 3 μm |
| Filler | (μm) | (l/m² bar h) | (%) | (l/m² bar h) |
| USY | 30 | 0.03 | 99.7 | 0.3 |
| ZSM-5 | 20 | 0.018 | 97.8 | 0.12 |

### Example 8

### Filtration experiments with PDMS membranes Filled with Nanosized Zeolite Filler

A casting solution of PDMS filled with nanocrystals of silicalite-1 was prepared as in EXAMPLE 4. The membranes were made as in EXAMPLE 6. The thicknesses of the 5-8 wt % (PDMS+filler) membranes were 3-5 μm.

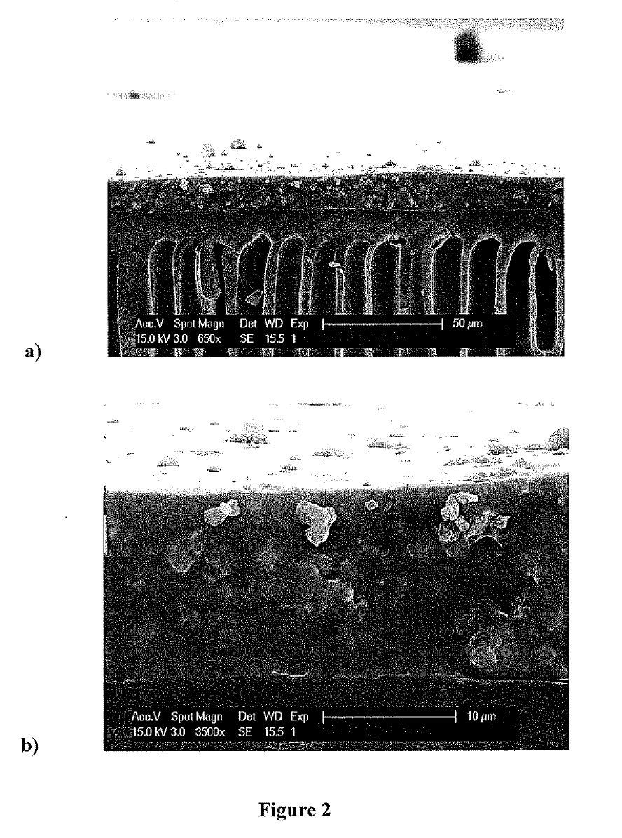

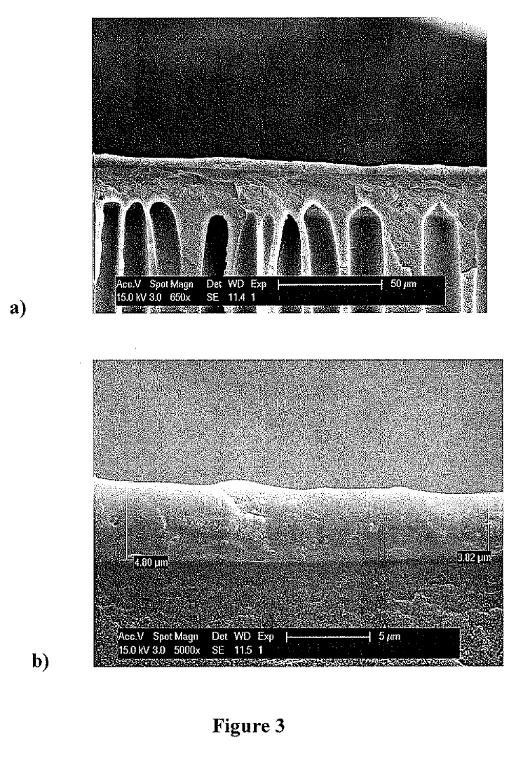

In FIG. 3, it is visible that the dispersion of these nanosized crystals in PDMS is bad compared to the dispersion of the micronsized fillers in EXAMPLE 7, as shown in FIG. 2.

| | | Thickness | | | Permeability |
|---|---|---|---|---|---|
| (PDMS + filler) | Si-1 in | of selective | | | normalized for |
| in hexane | PDMS | layer | Permeability | Rejection | thickness 3 μm |
| [Wt %] | [Wt %] | (μm) | (l/m² bar h) | (%) | (l/m² bar h) |
| 7 | 25 | 4 | 0.50 | 96.7 | 0.67 |
| 7 | 15 | 4 | 0.37 | 98.7 | 0.54 |
| 8 | 20 | 5 | 0.15 | 96.7 | 0.25 |
| 5 | 20 | 3 | 0.37 | 96.4 | 0.37 |

### Example 9

### Filtration Experiments with PDMS Membranes Filled with Micron-Sized Hollow Zeolite-Shell Filler

Hollow silicalite-1 shelled fillers were prepared as in EXAMPLE 1. The PDMS+filler solutions (7 and 15% in hexane) were made as in EXAMPLE 3. The membranes were made as in EXAMPLE 4. The thicknesses of the filled membranes are non-uniform. The 7% (PDMS+filler) membrane has an average thickness of 9 μm. The 15% (PDMS+filler) membrane has an average thickness of 15 μm.

| | | | | Permeability |
|---|---|---|---|---|
| | | | | normalized |
| (PDMS + | Thickness of | | | for thickness |
| filler) | selective layer | Permeability | Rejection | 3 μm |
| [Wt %] | (μm) | (l/m² bar h) | (%) | (l/m² bar h) |
| 7 | 9 | 0.71 | 99.7 | 2.13 |
| 15 | 15 | 0.28 | 99.9 | 1.4 |

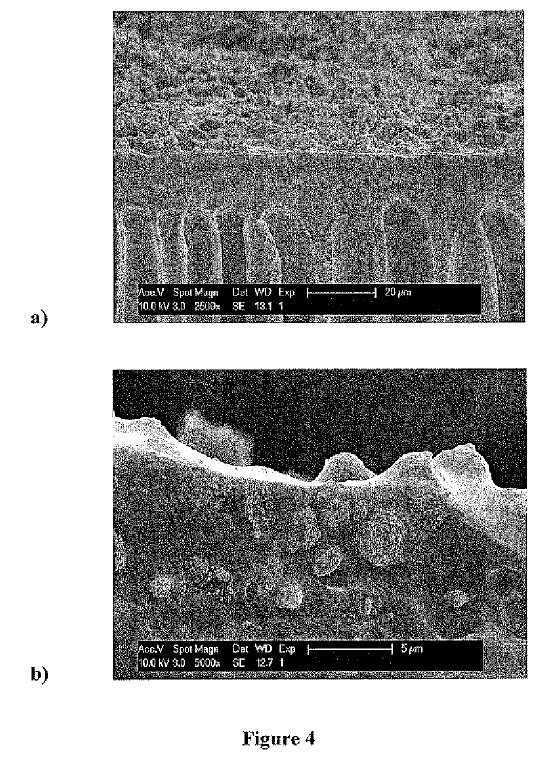

In FIG. 4, it is clear that the spheres are clearly imbedded in a PDMS matrix. Better uniformity of thickness may be expected with smaller sized hollow spheres and with optimised dispersion and casting conditions.

### REFERENCES

Boom, J. P., I. G. M. Punt, et al. (1998). “Transport through zeolite filled polymeric membranes.” Journal of Membrane Science 138(2): 237-258.
Botterhuis, N. E., Q. Y. Sun, et al. (2006). “Hollow silica spheres with an ordered pore structure and their application in controlled release studies.” Chemistry-a European Journal 12(5): 1448-1456.
Bourlinos, A. B., M. A. Karakassides, et al. (2001). “Synthesis and characterization of hollow clay microspheres through a resin template approach.” Chemical Communications (16): 1518-1519.
Caruso, F., R. A. Caruso, et al. (1998). “Nanoengineering of inorganic and hybrid hollow spheres by colloidal templating.” Science 282(5391): 1111-1114.
Chandak, M. V., Y. S. Lin, et al. (1997). “Sorption and diffusion of VOCs in DAY zeolite and silicalite-filled PDMS membranes.” Journal of Membrane Science 133(2): 231-243.
Chen, X., H. Yang, et al. (2001). “Preparation and characterization of HY zeolite-filled chitosan membranes for pervaporation separation.” Journal of Applied Polymer Science 79(6): 1144-1149.
Cheng, D. M., H. B. Xia, et al. (2006). “Fabrication of polymeric hollow nanospheres, hollow nanocubes and hollow plates.” Nanotechnology 17(6): 1661-1667.
Ding, X. F., K. F. Yu, et al. (2004). “A novel approach to the synthesis of hollow silica nanoparticles.” Materials Letters 58(27-28): 3618-3621.

Fowler, C. E., D. Khushalani, et al. (2001). “Interfacial synthesis of hollow microspheres of mesostructured silica.” Chemical Communications (19): 2028-2029.
Gao, Z., Y. Yue, et al. (1996). “Application of zeolite-filled pervaporation membrane.” Zeolites 16(1): 70-74.
Hentze, H. P., S. R. Raghavan, et al. (2003). “Silica hollow spheres by templating of catanionic vesicles.” Langmuir 19(4): 1069-1074.
Jan, J. S., S. J. Lee, et al. (2005). “Biomimetic synthesis of inorganic nanospheres.” Chemistry of Materials 17(17): 4310-4317.
Jia, M. D., K. V. Peinemann, et al. (1992). “Preparation and Characterization of Thin-Film Zeolite Pdms Composite Membranes.” Journal of Membrane Science 73(2-3): 119-128.
Kulak, A., Y. J. Lee, et al. (2002). “Anionic surfactants as nanotools for the alignment of non-spherical zeolite nanocrystals.” Advanced Materials 14(7): 526-+.
Kulprathipanja, S. (2003). “Mixed matrix membrane development.” Advanced Membrane Technology 984: 361-369.
Lee, S. and D. F. Shantz (2004). “Modifying zeolite particle morphology and size using water/oil/surfactant mixtures as confined domains for zeolite growth.” Chemical Communications (6): 680-681.
Lee, S. J. and D. F. Shantz (2005). “Zeolite growth in nonionic microemulsions: Synthesis of hierarchically structured zeolite particles.” Chemistry of Materials 17(2): 409-417.
Moermans, B., De Beuckelaer, W., Vankelecom, I. F. J., Ravishankar, R., Martens, J. A., Jacobs, P. A. (2000). “Incorporation of nanosized zeolites in membranes.” Chemical Communications (24) 2467-2468.
Mulder, M. (1996). Basic principles of membrane technology. Dordrecht, Kluwer Academic Publishers.
Naik, S. P., A. S. T. Chiang, et al. (2003). “Formation of silicalite-1 hollow spheres by the self-assembly of nanocrystals.” Chemistry of Materials 15(3): 787-792.
Song, W., R. Kanthasamy, et al. (2004). “Hexagonal, hollow, aluminium-containing ZSM-tubes prepared from mesoporous silica templates.” Chemical Communications (17): 1920-1921.
Vankelecom, I. F. J., J. DeKinderen, et al. (1997). “Incorporation of hydrophobic porous fillers in PDMS membranes for use in pervaporation.” Journal of Physical Chemistry B 101(26): 5182-5185.
Vankelecom, I. F. J., D. Depre, et al. (1995). “Influence of Zeolites in Pdms Membranes—Pervaporation of Water/Alcohol Mixtures.” Journal of Physical Chemistry 99(35): 13193-13197.
Vankelecom, I., Gevers, L., Jacobs, P. (2005). “Pressure driven separations of liquid feeds.” WO2005/058465-A2.
Venkatathri, N. (2006). “novel route to synthesis silica hollow spheres having ZSM-5 structure in absence of template.” Oriental Journal of Chemistry 22(2): 213-217.
Wang, X. D., W. L. Yang, et al. (2000). “Fabrication of hollow zeolite spheres.” Chemical Communications (21): 2161-2162.
Wang, Y., F. B. Su, et al. (2006). “Crystalline carbon hollow spheres, crystalline carbon-SnO2 hollow spheres, and crystalline SnO2 hollow spheres: Synthesis and performance in reversible Li-ion storage.” Chemistry of Materials 18(5): 1347-1353.
Xin Chen *, H. Y., Zhengyu Gu, Zhengzhong Shao (2000). “Preparation and characterization of HY zeolite-filled chitosan membranes for pervaporation separation.”
Xiong, C. R., D. Coutinho, et al. (2005). “Fabrication of hollow spheres composed of nanosized ZSM-5 crystals via laser ablation.” Microporous and Mesoporous Materials 86(1-3): 14-22.
Yang, W. L., X. D. Wang, et al. (2002). “Layer-by-layer assembly of nanozeolite based on polymeric microsphere: Zeolite coated sphere and hollow zeolite sphere.” Journal of Macromolecular Science-Pure and Applied Chemistry 39(6): 509-526.

1. A composite material comprising a polymer matrix, said polymer matrix comprising dispersed porous molecular sieve particles, wherein at least some of said porous molecular sieve particles are hollow, said hollow porous molecular sieve particles comprising a porous shell enclosing one or more cavities, and the volume of said one or more cavities is at least 8 times the average volume of the pores in said shell of said porous molecular sieve particles.

2. The composite material according to claim 1, wherein the volume of such cavity is at least 100 times the average volume of the pores in the shell of such particle.

3. The composite material according to claim 1, wherein the volume of such cavity is at least 1000 times the average volume of the pores in the shell of such particle.

4. The composite material according to claim 1, wherein at least 30% of the dispersed particles are hollow particles.

5. A composite material according to claim 1, wherein at least 60% of the dispersed particles are hollow particles.

6. The composite material according to claim 1, wherein at least 90% of the dispersed particles are hollow particles.

7. The composite material according to claim 1, wherein said polymer matrix is selected from the group consisting of polyvinylidene fluoride, polyacrylonitrile, polyvinylalcohol, polyimide, polysulfone, polyetheretherketone, polydimethylsiloxane and polybenzimidazole.

8. The composite material according to claim 1, wherein said porous molecular sieve particles are selected from the group consisting of zeolites, carbon-molecular sieves and porous silica.

9. A membrane comprising a composite material comprising a polymer matrix, said polymer matrix comprising dispersed porous molecular sieve particles, wherein at least some of said porous molecular sieve particles are hollow, said hollow porous molecular sieve particles comprising a porous shell enclosing one or more cavities, and the volume of said one or more cavities is at least 8 times the average volume of the pores in said shell of said porous molecular sieve particles.

10. The membrane according to claim 9 wherein said porous molecular sieve particles are selected to interact with said polymer matrix in order to provide additional cross-linking of said polymer matrix.

11. A gas or liquid separation process using a membrane comprising a composite material comprising a polymer matrix, said polymer matrix comprising dispersed porous molecular sieve particles, wherein at least some of said porous molecular sieve particles are hollow, said hollow porous molecular sieve particles comprising a porous shell enclosing one or more cavities, and the volume of said one or more cavities is at least 8 times the average volume of the pores in said shell of said porous molecular sieve particles.

12. The process according to claim 11, wherein said liquid separation process is a pressure driven process or an evaporation process.
